(19) United States
(12) Patent Application Publication
(10) Pub. No.: US 2011/0002672 A1
(43) Pub. Date: Jan. 6, 2011

(54) HEATER WITH IMPROVED AIRFLOW

(76) Inventors: Thomas E. Krapp, Holton, MI (US); David G. Gish, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/718,228

(22) Filed: Mar. 5, 2010

Related U.S. Application Data
(60) Provisional application No. 61/270,091, filed on Jul. 6, 2009.

(51) Int. Cl. F24H 3/02; H05B 3/02

(52) U.S. Cl. 392/360; 219/538

(57) ABSTRACT

The present room heater includes a housing supporting internal electric heat sources. The housing surrounds the heat sources with an interconnected serial series of chambers made from heat-conducting material. Air is motivated by an electric fan through the series of chambers to effect stepped uniform heating, as well as optimal heating as the air moves through preheat chambers and then closely past the heat sources to an outlet opening. The chambers are made using modular and relatively simply-made components that interfit to form the chambers, such that multiple configurations are possible, including stacked and laterally-adjacent versions. The modular components include a flat part, hat-shaped part, and U-shaped part that interfit to define a first elongated chamber and a second elongated chamber that wraps onto three sides of the first elongated chamber, the hat-shaped part having end-located notches to permit flow of air between the chambers.

This application claims benefit under 35 USC section 119(e) of provisional application Ser. No. 61/270,091, filed Jul. 6, 2009, entitled QUARTZ INFRARED HEATER WITH IMPROVED AIRFLOW DESIGN, the entire contents of which are incorporated herein in their entirety.

### BACKGROUND

The present invention relates to fluid heaters, and more particularly relates to room heaters, space heaters, and fluid heaters.

Known room heaters are capable of improvement. For example, many are complex and expensive to manufacture, and as a result overly expensive to consumers. Many are difficult and/or impossible to service and repair. Often they have poor air flow and/or do not provide a uniform heat in a good steady air flow. Many have a poor appearance that detracts from a room's décor.

In addition to the above, known room heaters are not modular, and hence they are not easily modified to provide higher heat units. Still further, they do not use common components, which drive up expense and complicate production. In addition, the known room heaters are not flexibly designed.

### SUMMARY OF THE PRESENT INVENTION

The present invention concerns a heater having one or more central heat sources, such as an infrared heater powered by electricity. The heater includes a housing forming a series of chambers around the heater and made from metal or other heat conductive material. Air is motivated by a fan through the series of chambers to effect stepped uniform heating, as well as optimal and uniform heating as the air moves through preheat chambers and then closely past the heat sources to an outlet opening. The chambers are made using modular and relatively simple components that interfit to form the chambers.

In one aspect of the present invention, a room heater includes a housing with walls dividing the housing into first and second preheat chambers both formed at least in part along different sides of a third chamber, such that heat generated in the third chamber preheats air in the first and second chambers. The first, second, and third chambers are serially interconnected to define a continuous air flow path with at least two switch backs. At least one heater is located in the third chamber and at least one blower is configured to motivate fluid along the air flow path.

In another aspect of the present invention, a room heater comprises a housing assembly including top and bottom plates, a front plate, at least one side plate, at least one inner chamber plate and at least one outer chamber plate assembled to define first and second preheat chambers extending around a third chamber, with each of the first, second, and third chambers being serially interconnected to define a continuous air flow path in which air flows back and forth a majority of a length of the housing assembly at least twice during movement along the continuous air flow path. The room heater also includes at least one heating element and at least one air motivator for motivating air through the air flow path.

In another aspect of the present invention, a heater includes a flat part and a hat-shaped part that combine to form an elongated heating chamber. A U-shaped part is assembled in a sandwiched arrangement around the hat-shaped part to define pre-heat chambers around and along the heating chamber. One of the flat part, the hat-shaped part, and the U-shaped part have an opening allowing flow from the pre-heat chambers to the heating chamber.

In still another aspect of the present invention, a room heater comprises a housing assembly defining elongated chambers defining a continuous air-flow path that extends back and forth a length of the housing assembly at least three times; the air-flow path including a heating chamber section with at least one heating element therein. The room heater also includes a sleeve shaped to receive the housing assembly and having an aesthetically treated outer surface, with an inner surface of the sleeve forming with the housing assembly an outer portion of the continuous air-flow path.

Objects of the invention include high performance, power and efficiency; a relatively small compact size; aesthetic appearance and one that can be easily modified for particular aesthetic considerations; ability to mount vertically or be floor mounted; easy to service; and modular in design.

An object is to provide interchangeable shells and shell designs, thus allowing optimal aesthetics and consumer selection.

An object is to provide modularity allowing components to be used in smaller and/or larger, higher-output designs.

An object is to provide a room heater that can be mounted vertically or horizontally.

An object is to provide a room heater that remains sufficiently cool to be touched on the outside, while also providing significant room heat.

An object is to provide a room heater that puts out heat in an efficient, uniform, and powerful manner.

An object of the present invention includes providing methods of operation expressed by using the arrangement as defined above.

An object of the present invention is to provide an aesthetic design that, in addition to being useful, is also novel, ornamental, and unobvious over known designs, including providing surprising and unexpected benefits of appearance and ornamental value.

These and other aspects, objects, and features of the present invention will be understood and appreciated by those skilled in the art upon studying the following specification, claims, and appended drawings.

### BRIEF DESCRIPTION OF DRAWINGS

FIG. 1 is a front perspective view of a side-by-side-chamber single-fan room heater embodying the present invention, and FIG. 1A is a similar view with the outer shell eliminated to better show the inner housing assembly.

FIGS. 2 and 2A are rear perspective views of FIGS. 1-1A respectively.

FIGS. 3-5 are top, rear, and side orthogonal views of FIG. 1, FIG. 4 being a cross section along line IV-IV in FIG. 3.

FIGS. 6-8 are front perspective, rear perspective, and rear views of a modified single-side-chamber single-fan room heater assembly not unlike that shown in FIGS. 1A, 2A and 4.

FIG. 9 is an exploded view of FIG. 2.

FIG. 10 is a partially assembled view of FIG. 9, and showing air flow through preheat and final heat chambers.

FIG. 11 is a front perspective view of a modified stacked-chamber heater including its outer shell, and FIG. 12 is an exploded front perspective view of FIG. 11.

FIGS. 13-14 are front and rear perspective views of the modified heater of FIG. 11.

FIGS. 15-17 are top, rear, and side views of FIG. 13.

FIG. 18 is a perspective view showing air flow through the room heater of FIG. 11.

FIG. 19 is an exploded view of FIG. 14.

FIG. 20 is an exploded perspective view of a modified room heater similar to the heater of FIG. 19 but including three heating elements instead of only two.

### DETAILED DESCRIPTION OF PREFERRED EMBODIMENTS

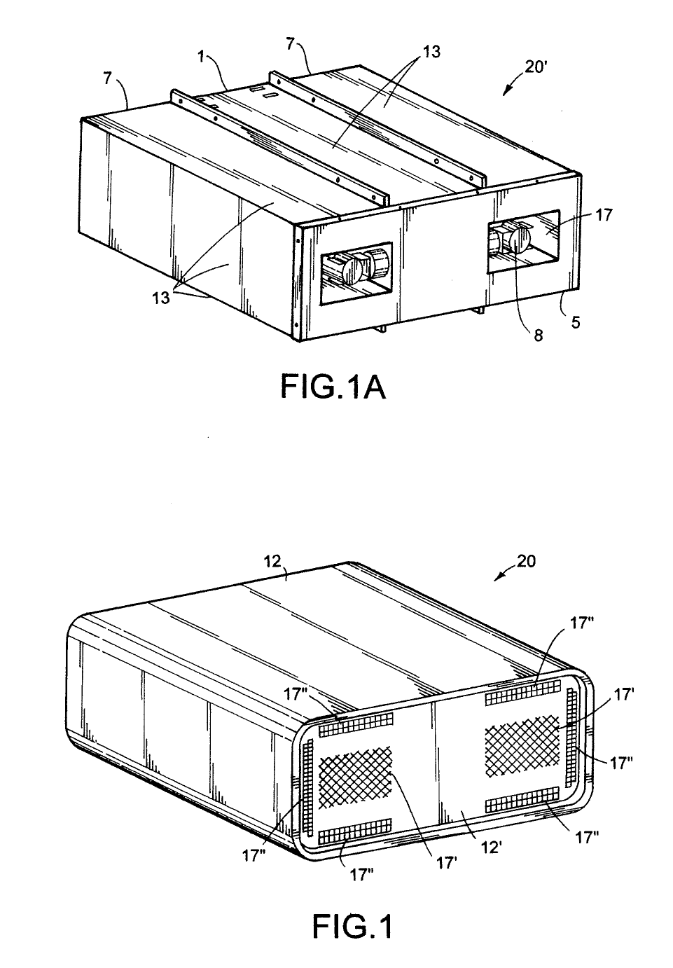

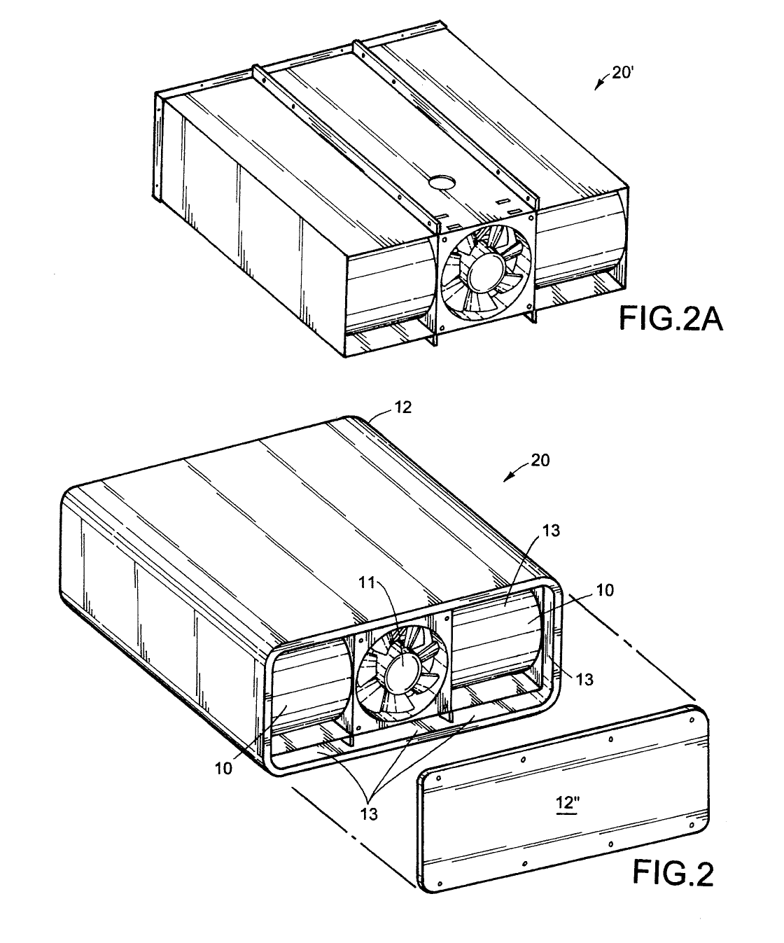

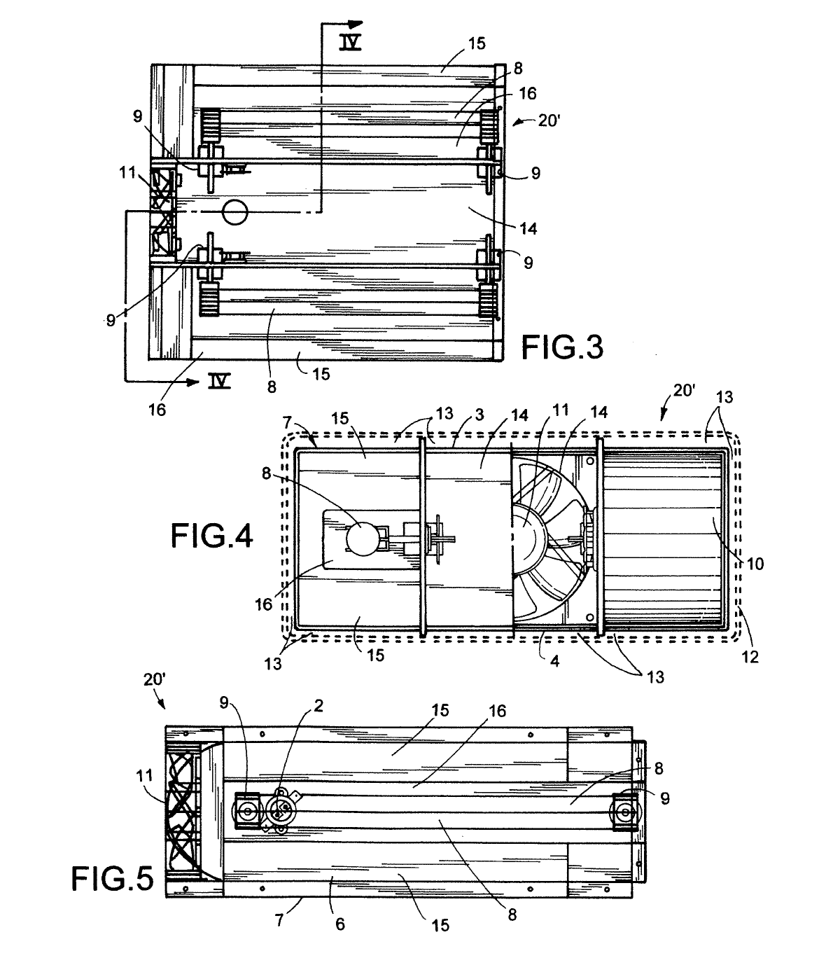

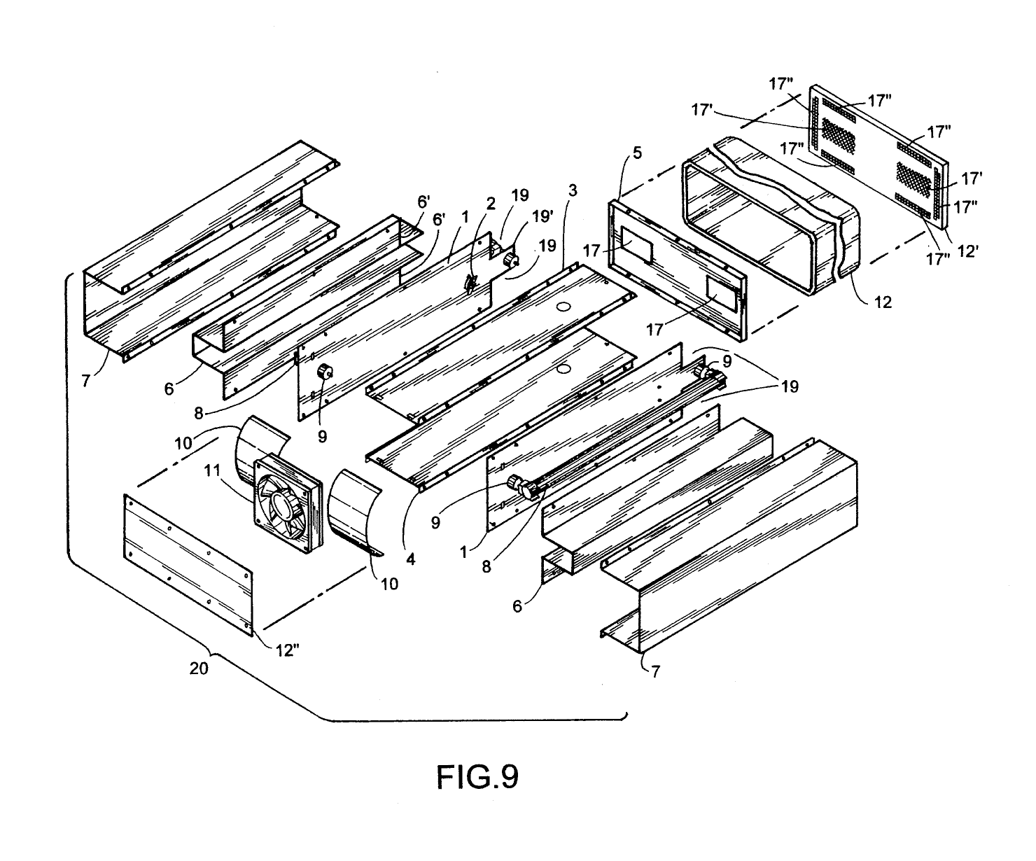

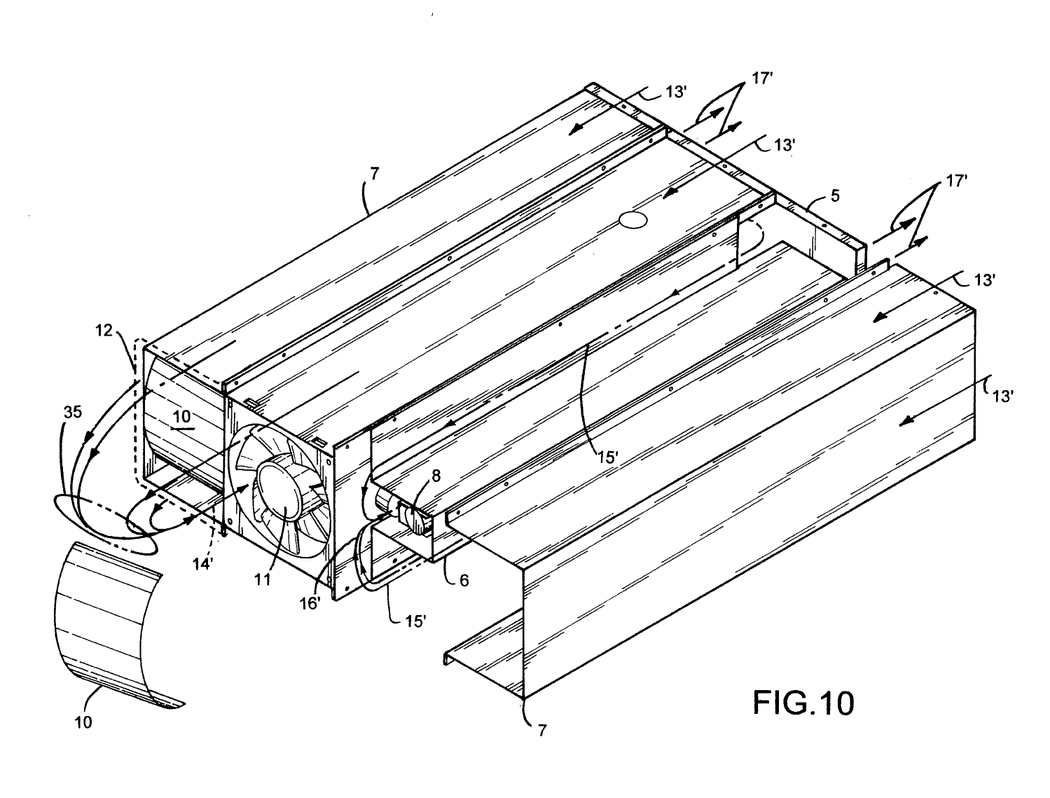

The illustrated room heater 20 (FIGS. 1-5, 9-10) (also called “space heater” or “heater apparatus”) is a side-by-side double-sided chamber, single-fan room heater embodying the present invention. FIGS. 1 and 2 show a housing assembly 20′ covered by an outer shell 12 and by face and back end covers 12′ and 12″, each having an aesthetic shape and aesthetic outer surface. The room heater 20 includes multiple wall-forming metal members 1, 3, 4, 5, 6, and 7 (FIG. 9) (also called “plates”) that when assembled form the housing assembly 20′ defining multiple back-and-forth tortuous paths for air. The paths (FIG. 10) include a first path 13′, along a first outermost preheat chamber(s) 13 (inside the shell 12 but outside the outer walls of the plates 3, 4 and 7 of the housing assembly 20′), a second path 14′ along second outer preheat chamber(s) 14 (centered and between plates 1, 1, 3, 4 of the housing assembly 20′), a third path 15′ along intermediate preheat chamber(s) 15 (between right side plates 6, 7 and between left side plates 6, 7), and a fourth path 16′ along a final heating chamber(s) 16 (inside the channel defined by plate 6). The heater elements 8 are positioned in the final heating chamber 16, and heat from this chamber 16 preheats the other chambers 13-15 due to its location and relative position. The uniformly heated air exits the heater 20 at outlet opening(s) 17 in plate 5 and opening 17′ in the end cover 12″.

It is noted that the term “plates” is sometimes used herein, but the term is not intended to be unnecessarily limiting. Specifically, the term “plates” is intended to include parts made from sheet stock and/or that are formed into sheet-like components, such as a stamping, a formed sheet metal part, a bracket-like stamped part, a break-formed component made from sheet metal, and/or a part molded from polymer (e.g., injection molding, thermoforming, compression molding, etc).

The illustrated heater 20 includes one (or more) disk thermometer 2 (FIG. 9) along with electrical circuitry to control temperature and air flow, and fuse clips 9 that support the heater elements 8 (also called “heaters”). This circuitry and control technology does not require detailed explanation for an understanding by persons skilled in this art. The illustrated heater elements 8 are preferably electric infrared emitters, but it is contemplated that they can include other heaters, such as kerosene or gas. The illustrated heater 20 also includes curved baffles 10 at the end of chambers 15-16 to cause a more laminar and efficient air flow from chamber 15 into the chamber 16 during a last one of the air switch backs. A fan 11 is positioned to draw air thru inlet openings 17″ along the outermost chamber 13 and then motivate the air into and through the chamber 14 (and subsequently serially through the chambers 15-16 in series) of the heater 20.

The side plates 1 are generally flat rectangular sheet metal panels with notches 19 cut out at one end and including holes for fuse clips 9 and for thermometer 2 and for attachment screws. The side plates 1 include tabs 19′ between notches 19 that close the chamber 16 at the front end so that air flow is forced from chamber 14 through notch 19 reversely into chambers 15. Top and bottom plates 3 and 4 are mirror images and generally flat and rectangular sheet metal panels, with attachment flanges along each side edge. Front end exit plate 5 has openings 17 for outlet of heated air and a perimeter flange for attachment to the end edges of the plates 3, 4, 7. Front cover 20″ has matching grill-covered openings 17′ for output of heated air, and further has grill-covered openings 17″ for input of ambient air into the chamber 13. Inner chamber plate 6 has a hat-shaped cross section that extends its length, with its side flanges 6′ cut short to align with notches 19 (or holes). Outer chamber plate 7 is U-shaped and matably receives the inner chamber plate 6. Notably, inner chamber plate 6 is slightly shorter than outer chamber plate 7 and side plate 1, such that air can flow around the un-notched rear end of the inner chamber plate 6 from chamber 15 into chamber 16. The infrared emitter electrical heater 8 are designed to electrically connect between the clips 9. Curved baffles 10 and fan 11 are selected and sized to fit into their respective spaces. The curved baffles 10 are flexible sheets that can be resiliently bent and fit into their space, with their resiliency creating friction to hold them in place.

Alternative embodiments and modifications are contemplated to be within a scope of the present invention. For example, the present inventive heater can be constructed using different shaped chamber walls (e.g., cylindrical). Also, it can be built with different heating elements (e.g., round bulbs) or with a different heat source other than infrared (e.g., gas or kerosene). It also includes different preheat chamber layouts and airflow directions. For example, more or less preheat chambers can be constructed (e.g., eliminating a shell where those aesthetics and function are not required), as well as different decorative shells can be used (e.g., different shapes and/or ornamentation). A wide variety of different materials can be used, including high temperature plastics, metals, or composites, and with differently coated surfaces. For example, see heaters 20A-20C described below. Still further, the air flow direction and preheat designs could also be used to heat substances other than air (e.g., water, gaseous fluids other than air or water, etc).

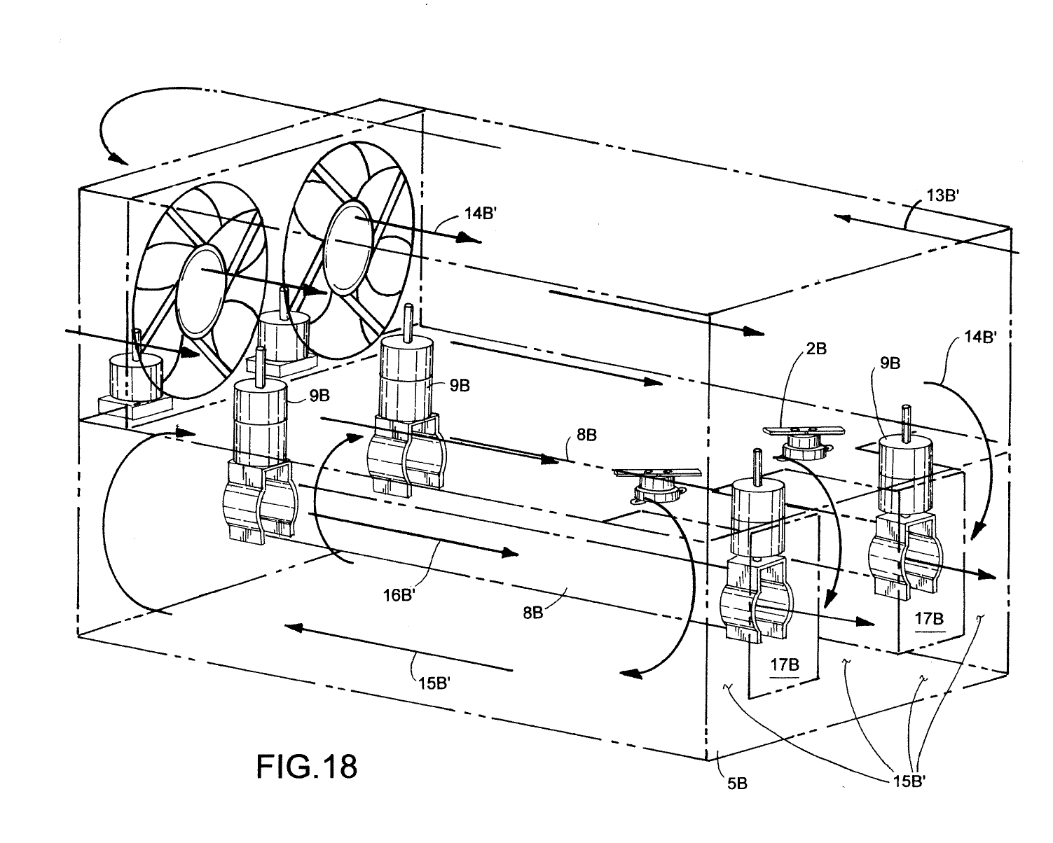

Operation: The air flow pattern for heater 20 is shown in FIG. 10. (Compare that shown in FIG. 18.) The heater 20 is plugged in and its thermostat adjusted to a desired temperature and/or the fan 11 is adjusted to a desired air flow rate. As the heating elements warm up, the fan 11 draws air inside the shell around all sides of the housing 20′, flowing along chamber 13 and reversing direction at locations 35 on each side into the fan 11 and into the chamber 14. The air then flows along the chamber 14 until it is forced to switch back and move laterally through notches 19 and flow in a 180 degree reverse direction along chamber 15. At the end of chamber 15, the air again reverses with the assistance of baffles 10 and flows into and along chamber 16 along the heater 8 where the air is heated. The fully heated air then exits openings 17 and 17′ in the front cover 20″. Due to shared walls, air flowing along chamber 16 preheats the air flowing along chamber 15. Similarly, air flowing along chamber 15 preheats air flowing along chamber 14. Also, air flowing along chamber 14 preheats the air flowing along chamber 13. This leads to a very efficient and uniform heating process. The effect is heated air that is exceptionally uniform and well-heated, and that is very quickly evenly heated during start up of the heater(s) 20.

Our test data suggests to us that the present room heater 20 has a substantially improved efficiency and uniformity of heated air flow over another well known stand-alone heated/forced-air room heater in generated air temperature by as much as 25% during constant operation. Specifically, we measured the present room heater 20 to provide a temperature of about 210 degree F. while one known prior art room heater was only able to provide a measured temperature of about 155 degree F. at a similar output location and time period. We are still trying to understand and explain this improvement, but believe it to be related at least in part to the efficient and uniform heating of air provided in the present room heater 20, which is due in significant part from the preheat and air chamber arrangement(s) of the present room heater 20. We believe our design leads to considerably more efficient and uniform heating of air over known prior art room heaters due to less turbulence and less “hot spots”, even when they have a heater element with similar btu/hour rating and heating capacity.

The room heaters 20A-20C use the same identification numbers as heater 20 but with an additional letter “A” or “B” or “C” for identical or similar components. This is done to reduce redundant discussion.

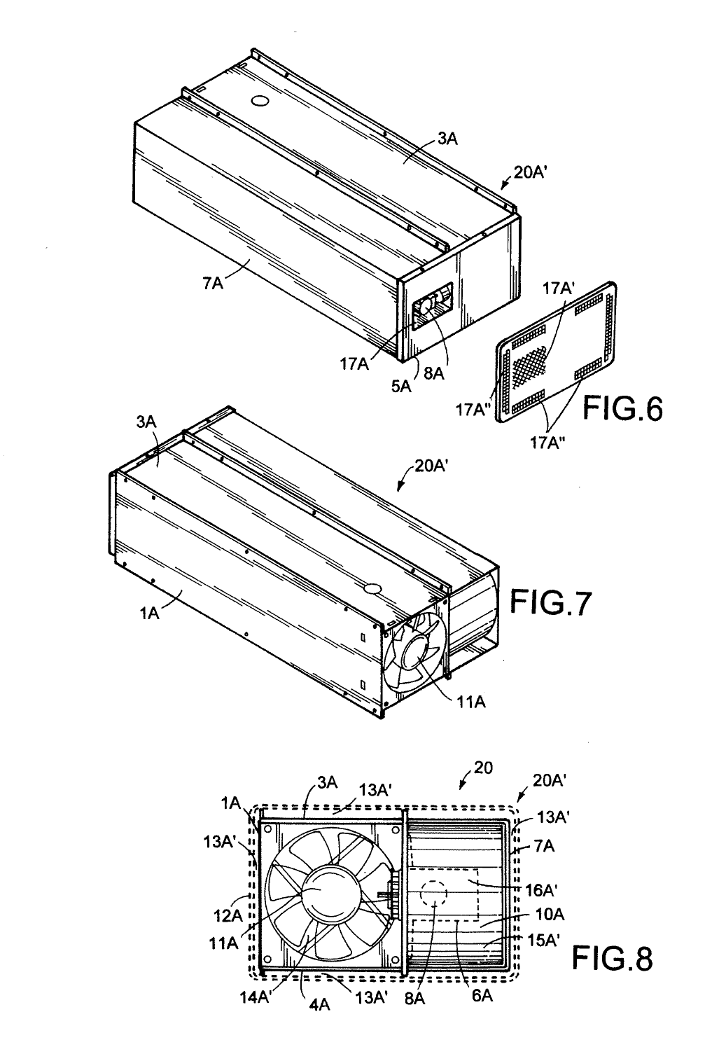

The room heater 20A (FIGS. 6-8) is made using similar components, but with a single-side-chamber arrangement. Specifically, room heater 20A (FIGS. 6-8) includes an emitter 8A (also called “heating element” or “heater”) mounted on a side plate 1A by fuse clips 9A. The fuse clips 9A are wired to a power cord and control circuitry (such as an on-off switch and/or fuse and/or other heat and air flow controls, using well-known electrical components). The control circuitry can be located on the shell 12A or in other locations on the unit 20A. The illustrated side plate 1A is rectangular and extends a full length of the unit, except for two square notches (or rectangular sections) cut out at the exit end of the unit 20A above and below the emitter 8A. When assembled, these two spaced notches allow air to flow from the outermost chamber 13A to the preheat chambers 14A. The thermometer 2A is mounted on one side plate 1A and wired in.

The long rectangular top and bottom plates 3A and 4A are then attached to the sides 1A creating a box with two open ends and with the emitter 8A mounted on one side 1A as shown. The inside of this box will be the fan chamber, chamber 14A. The first inner chamber plate 6A is then attached to the side plate 1A fitting over and covering the emitter 8A and creating the emitter chamber 15A. Inner chamber plate 6A has a hat-shaped profile, so that it defines the inner chamber 15A, but also defines on its top, side, and bottom the chamber 14A along with three-sided U-shaped out chamber housing 7A (also called an outer wall-forming plate 7A). The outer chamber housing 7A is attached to the side plate 1A, fitting over the inner plate 6A. The spaces between these two outer plates now form the outer preheat chambers 13A.

Next, the fan 11A is attached to the intake side of the fan chamber 13A on the opposite side to the cutout sections of the side plate 1A. A piece of thin resilient metal, curved baffle 10A, is bent into a curve and inserted into the intake side opening of the emitter chamber 13A, next to the fan. It is held in place by its own tension against the back of the emitter chamber 14A, thereby sealing off the end of the chamber and creating a curved baffle. Next, a front plate 5A (double model as shown) is attached to the exit end of the unit, which seals the other side of the preheat chambers except for the exit hole. The tubular sleeve shell 12A is then assembled onto the unit to complete the assembly. Inlet air flows between the sleeve shell 12A and the outer surfaces of the plate assembly, Air then reverses (“switches back”) to flow along the first pre-heat chamber, then reverses to flow along the second pre-heat chamber, then reverses to flow through the heating chamber and out into the room.

The heater 20A eliminates one of the plates 6 and eliminates one of the plates 7 found in heater 20, but nonetheless uses a majority of the same components as heater 20.

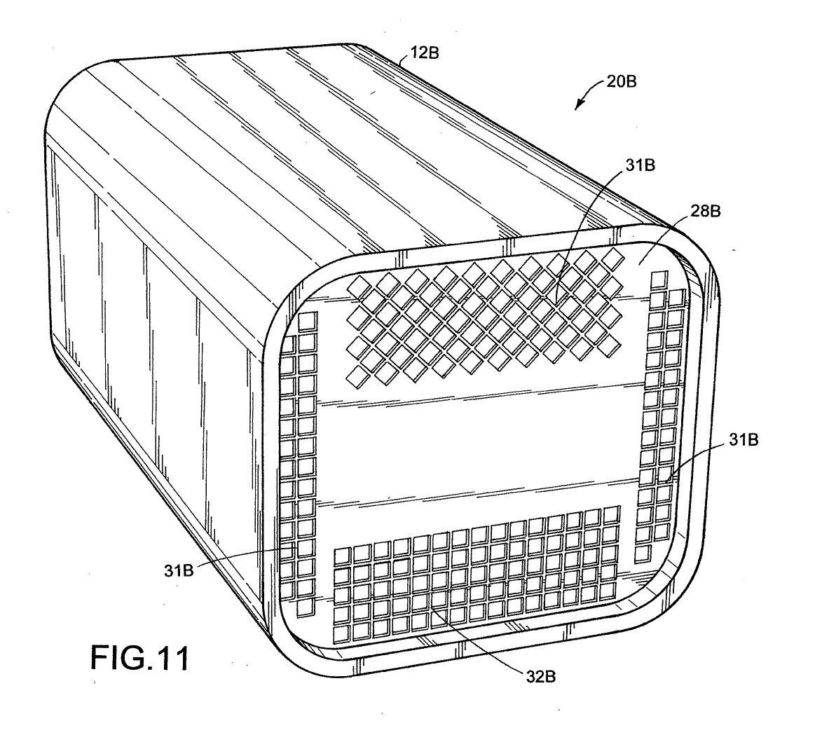

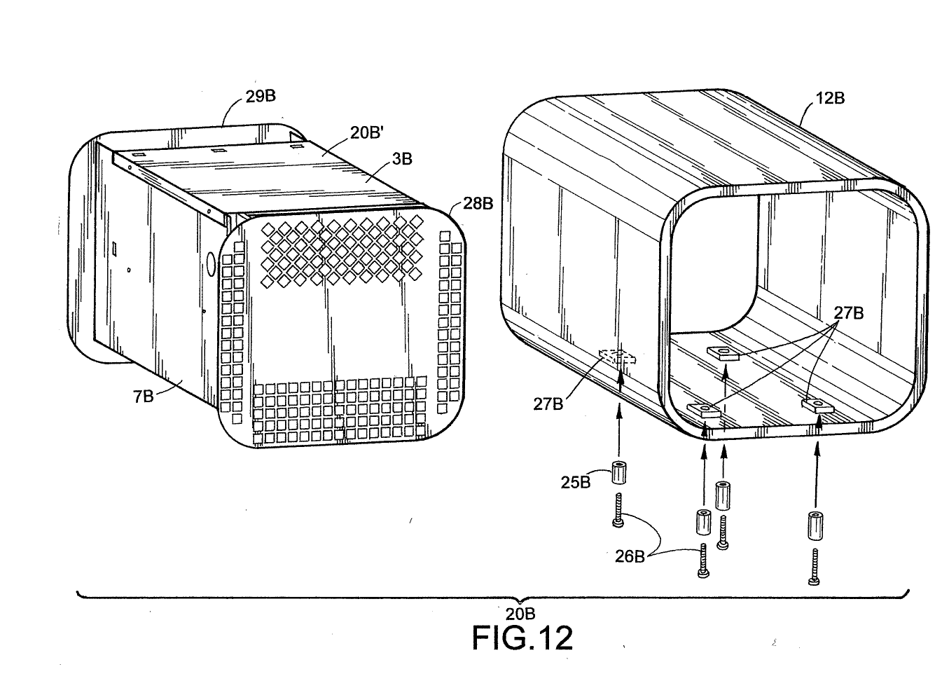

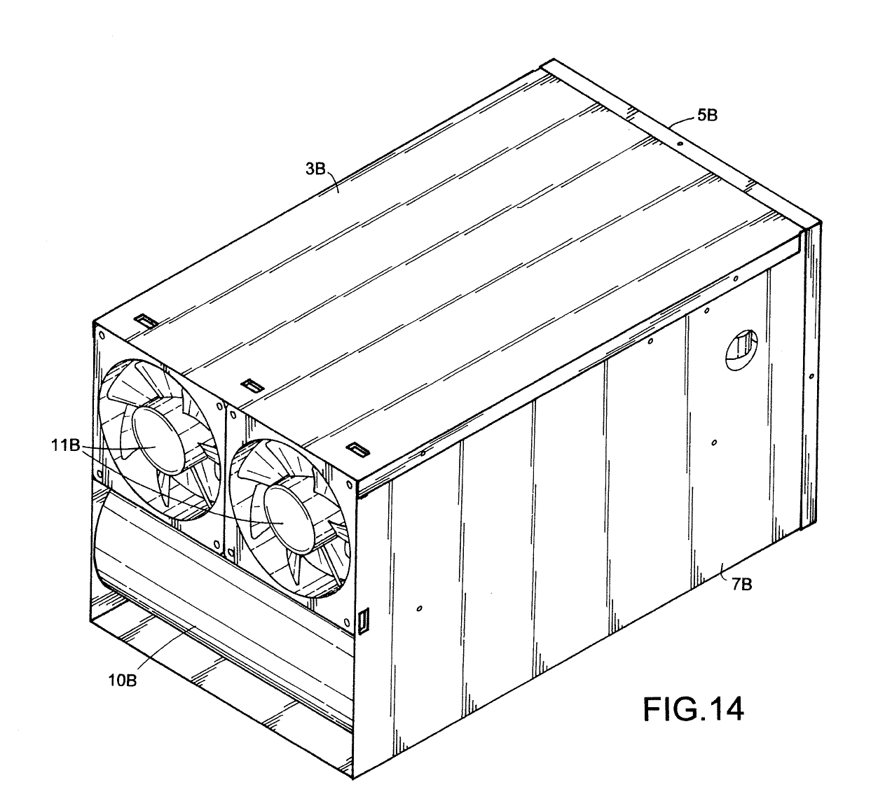

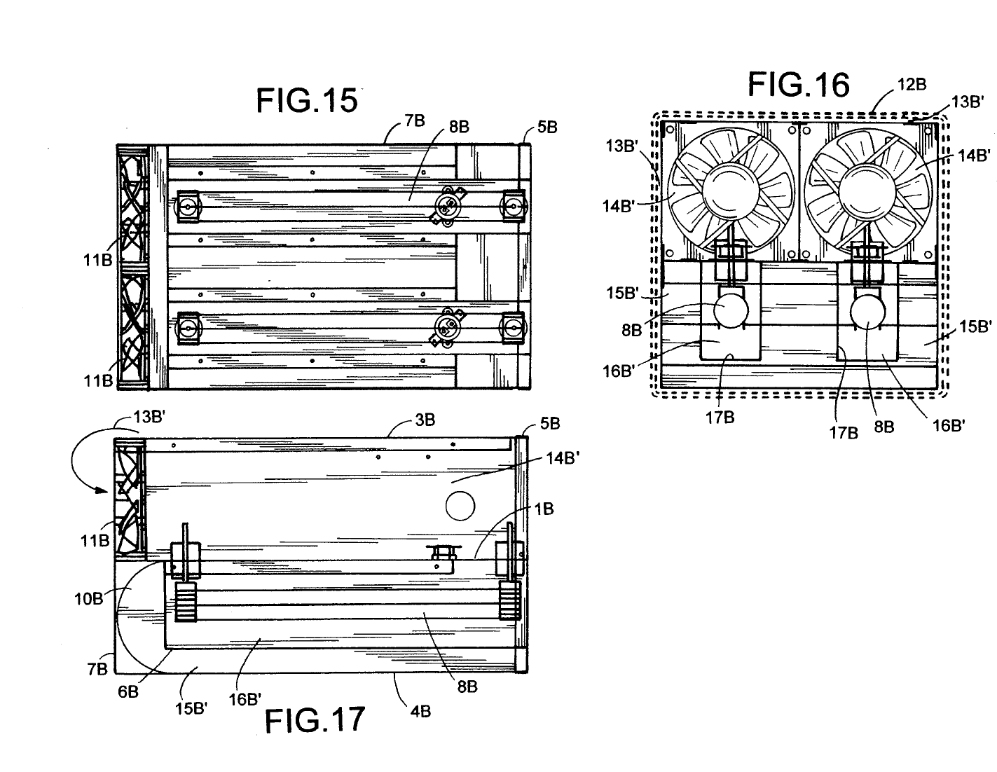

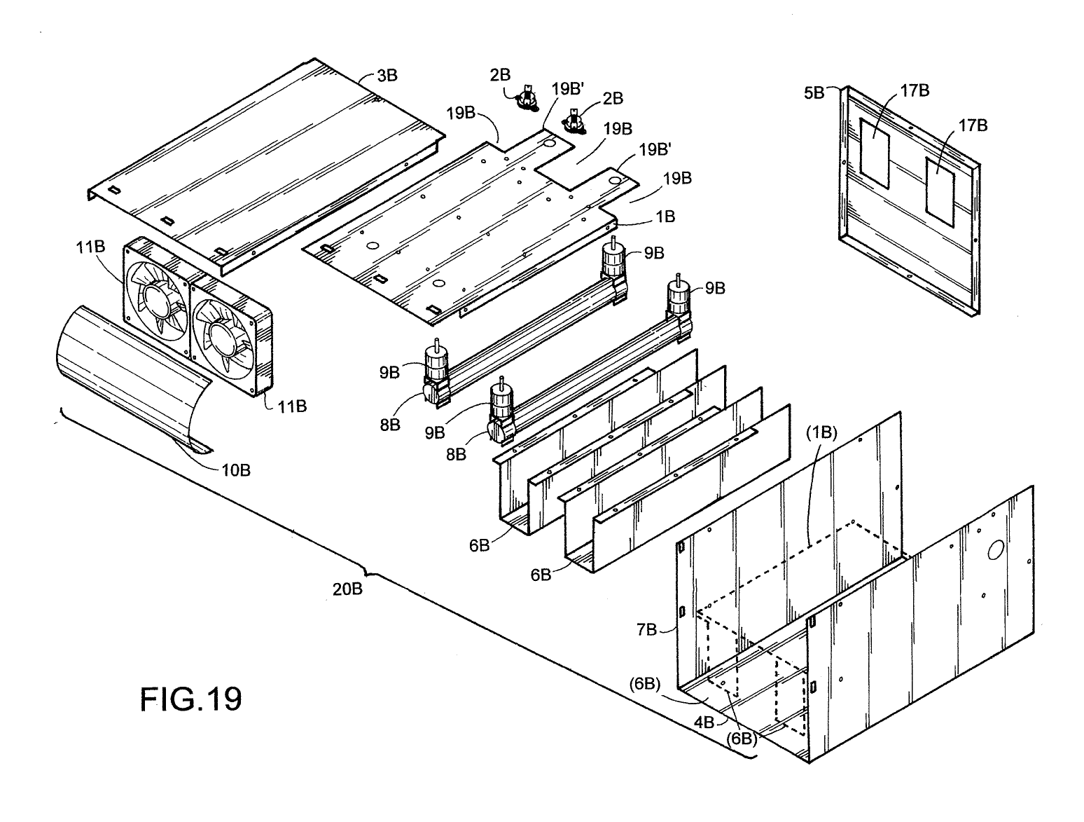

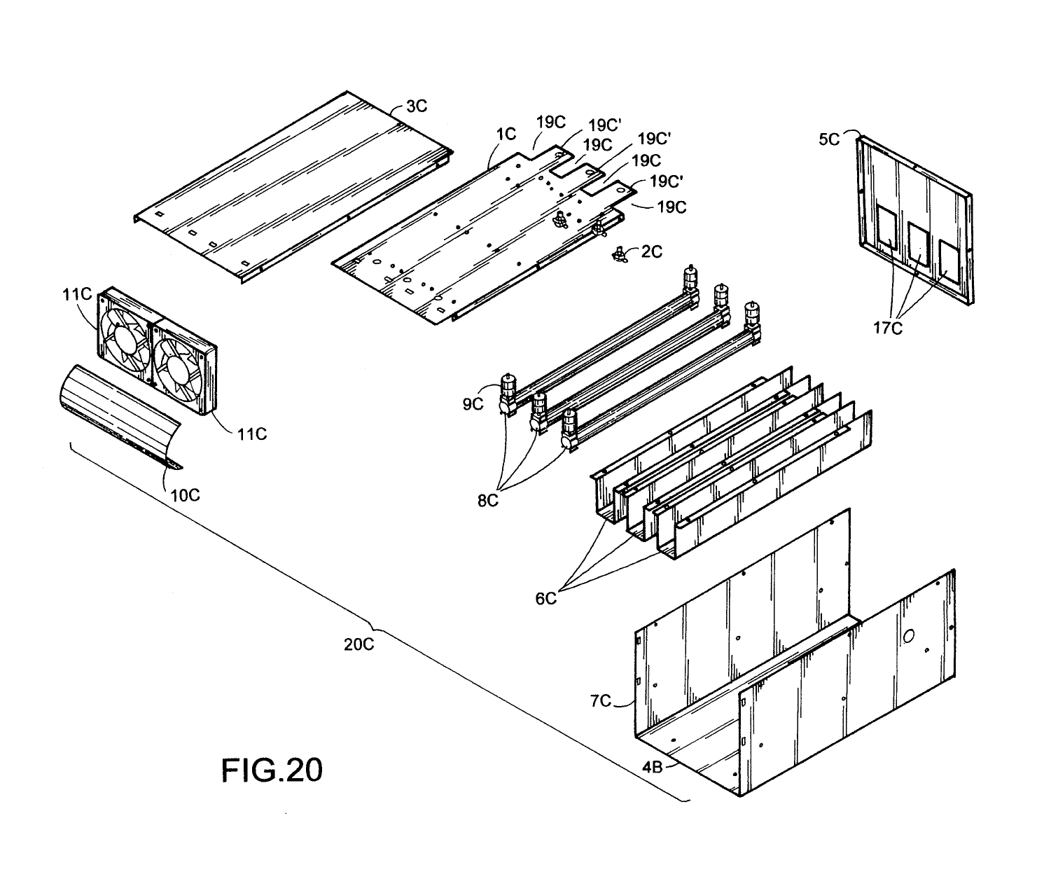

A stacked two-element room heater 20B (FIGS. 11-19) and a stacked three-element room heater 20C (FIG. 20) are shown using components similar to those described above. They include similar components and similar switch-back air flow. Specifically, the heater 20B includes two fans 11B that draw air from an outer chamber 13B into a top half of the top-located chamber 14B. The air flows along a length of the top chamber 14B, and then down through openings formed by notches 19B at an end of the divider flat plate 3B downwardly to the lower half of the assembly. The air then flows first into chambers 15B formed around the outside of the hat-shaped members 6B and then reverses to flow along chambers 16B formed within the hat-shaped members 6B, each of which contain a heater 8B.

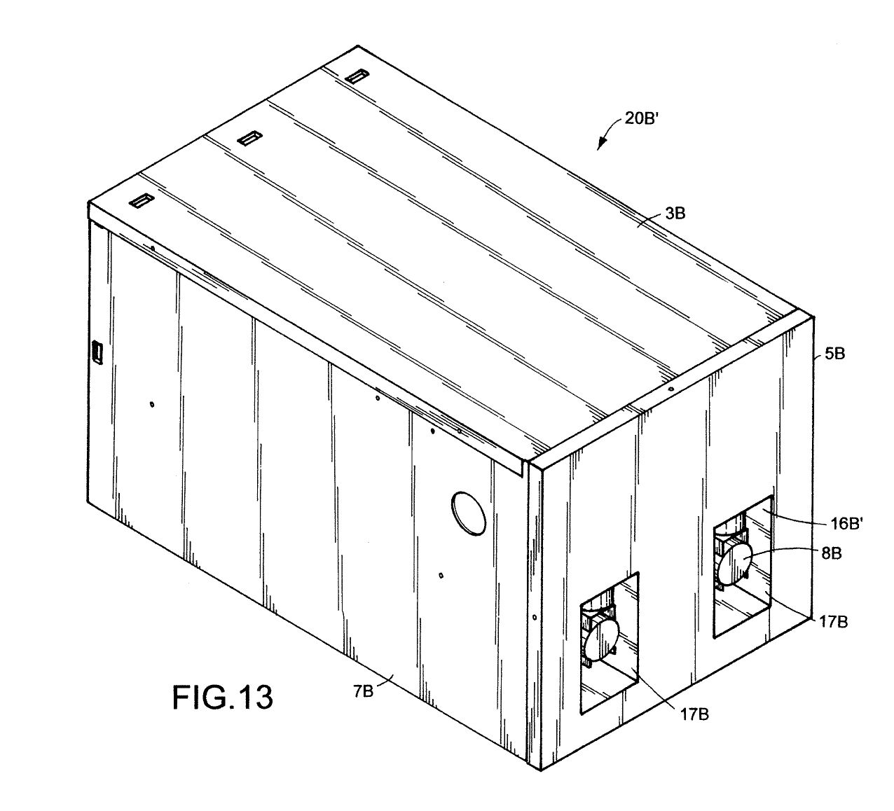

The shell 12B (FIGS. 11-12) includes a tubular shape with flattened sides and rounded corners for receiving the assembly shown in FIG. 13. The rounded corners of the shell 12B help cause the shell 12B to form a space 360 degrees around the housing assembly 20B′ and that extends a length of the housing assembly 20B′. Rubber feet or standoffs 25B are attached to a bottom of the shell 12B such as by screws 26B that engage embed (or weld-attached) nuts 27B in a bottom of the shell 12B. A front grill or cover 28B and rear cover 29B″ is attached to ends of the shell 12B, the grill 28B at the air outlet end including a grill area 31B of openings for allowing air inlet and a grill area 32B of openings allowing air exit, without undesired mixing of the inflowing and outflowing air. The mesh covering of the areas 31B and 32B help eliminate safety concerns of things being poked into the heater unit 20B. Notably, the present room heater (FIG. 11) can be set horizontally on a floor, including placement against a wall or furniture. It is also contemplated that the heater unit 20B (and/or units 20-20A and 20C) also can be mounted vertically on a wall.

The heater 20C is similar to heater 20B, but heater 20C includes three hat-shaped plates 6C (instead of two) and three heaters 8C (instead of two).

It is contemplated that the present inventive concepts can be used to heat any gas or fluid, and that they present concepts that are not limited to only air, nor to only room and space heaters.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A heater comprising:
a housing with walls dividing the housing into first and second preheat chambers both formed at least in part along different sides of a third chamber, such that heat generated in the third chamber preheats air in the first and second preheat chambers;
the first, second, and third chambers being serially interconnected to define a continuous air flow path with at least two switch backs; at least one heater being located in the third chamber and at least one blower configured to motivate fluid along the continuous air flow path.

2. The heater defined in claim 1, wherein the walls of the housing are formed in part by a hat-shaped member and a U-shaped member that together form the third chamber.

3. The heater defined in claim 2, wherein the preheat chambers are outside the hat-shaped member, and including the heater located inside a cavity formed in part by three walls of the hat-shaped member.

4. The heater defined in claim 2, wherein one of the walls forms part of both the first and third chambers.

5. The heater defined in claim 2, wherein the walls include three walls that form the hat-shaped member forming part of both the second and third chambers.

6. The heater defined in claim 1, including a tubular sleeve that fits around the housing and that includes an aesthetic outer surface.

7. The heater defined in claim 6, wherein the sleeve and an outside of the housing form a fourth chamber providing an inlet air flow to the first chamber.

8. The heater defined in claim 1, including a curved baffle at one end of at least one of the first and second chambers.

9. A heater comprising:
a housing including top and bottom plates, a front plate, at least one side plate, at least one inner chamber plate and at least one outer chamber plate assembled to define first and second preheat chambers extending around a third chamber, with each of the first, second, and third chambers being serially interconnected to define a continuous air flow path in which air flows back and forth a majority of a length of the housing assembly at least twice during movement along the continuous air flow path; and
at least one heating element and at least one air motivator for motivating air through the air flow path.

10. The heater defined in claim 9, wherein the continuous air flow path includes first, second, and third sequentially connected chambers, and including a single common wall defining part of first and third chambers.

11. The heater defined in claim 10, wherein the housing includes three walls of a hat-shaped member that forms part of the second and third chambers.

12. The heater defined in claim 9, including a tubular sleeve around the housing.

13. The heater defined in claim 12, wherein the sleeve defines with an outside of the housing a fourth chamber providing inlet air flow to the first chamber.

14. A heater comprising:
a housing including a flat part and a hat-shaped part to define an elongated heating chamber, and a U-shaped part assembled in a sandwiched arrangement around the hat-shaped part to define pre-heat chambers around and along the heating chamber, with one of the flat part, hat-shaped part, and U-shaped part having an opening allowing fluid to flow from the pre-heat chambers to the heating chamber.

15. The heater defined in claim 14, wherein the preheat chambers are outside of and wrap partially around an outside of the hat-shaped member, and including a heater inside a cavity defined by the hat-shaped member.

16. The heater defined in claim 14, wherein the flat part includes a single common wall defining part of first and third chambers.

17. The heater defined in claim 14, wherein the hat-shaped part includes three walls that form part of second and third chambers.

18. The heater defined in claim 14, including a tubular sleeve extending around the housing, the sleeve having an aesthetic outer surface.

19. The heater defined in claim 18, wherein the sleeve forms with an outside of housing a fourth chamber providing an inlet air flow to the first chamber.

20. A heater comprising:
a housing assembly defining elongated chambers defining a continuous air-flow path that extends back and forth a length of the housing assembly at least three times; the air-flow path including a heating chamber section with at least one heating element therein; and
a sleeve shaped to receive the housing assembly and having an aesthetically treated outer surface, with an inner surface of the sleeve forming with the housing assembly an outer portion of the continuous air-flow path.
